(19) United States
(12) Patent Application Publication
(10) Pub. No.: US 2002/0063140 A1
(43) Pub. Date: May 30, 2002

(54) FLEXIBLE CONTAINER

(76) Inventors: ROBERT J. CROFT, JERSEY CITY, NJ (US); MARTIN C. SHORT, NEW YORK, NY (US); JIM WARNER, HOBOKEN, NJ (US)

Correspondence Address: FITZPATRICK CELLA HARPER & SCINTO, 30 ROCKEFELLER PLAZA, NEW YORK, NY, 10112, US

(21) Appl. No.: 09/316,004

(22) Filed: May 21, 1999

(51) Int. Cl. B67D 5/56

(52) U.S. Cl. 222/129.1; 138/30

(57) ABSTRACT

A flexible container for storing fluid includes a body and a neck portion. The body has a hollow interior and is formed of at least one flexible sheet. The neck portion is integral with the body and is formed of the flexible sheet. The neck portion defines a discharge passage between the hollow interior of the body and an opening. The discharge passage of the neck portion has a width in a range of 0.25-0.50 in. when sides of the flexible sheet are flat against one another at the neck portion, and a length between the body and the opening in a range of 0.37-0.62 in. With this design, fluid having a viscosity and a density around that of water will be discharged at an optimum discharge angle and discharge pressure.

### FIELD OF THE INVENTION

The present invention relates to a flexible, collapsible container for storing fluid. In particular, the present invention relates to a container, having a tear-off neck, for storing a liquid, such as an additive, to be mixed with a beverage in a vessel.

### BACKGROUND OF THE INVENTION

Flexible containers or pouches for storing liquids are known. Many flexible pouches for storing a consumable liquid include a tear-off neck to form the discharge opening in the container. However, once the neck is torn off, typically there is no way to reseal the opening. Accordingly, should the container be laid on its side, the liquid may leak out, especially if it is of a relatively low viscosity, close to that of water. Moreover, when the liquid is intended to be emptied from the container, there is no way to reliably control the flow of the liquid. For example, if the liquid is to be poured into a cup or other vessel as the flexible container is tilted in a pouring position and squeezed, the liquid may either dribble over the sides of the container or spurt out at an excessive rate depending upon the dimensions and shape of the opening.

Methods have been proposed for controlling the flow of fluid through the neck of a flexible container with a tear opening. For example, U.S. Pat. No. 2,815,150 describes incorporating a closure portion formed of a rigid or flexible rib or clip of metal into the neck portion of a squeeze container. The closure can close the discharge opening against emission of the contents of the container, unless sufficient pressure is applied to the container. However, this is a complicated design and although the closure can prevent leaking of the liquid when the container is laid on its side, the applied pressure necessary to expel the liquid can preclude a controlled expulsion flow of the liquid.

### SUMMARY OF THE INVENTION

It is, therefore, an object of the present invention to provide a flexible container of simple design that can retain stored liquid even when the container is opened. It is another object of the present invention to provide a flexible container with which a user can control the pouring position at which stored liquid will be discharged.

It is yet another object of the present invention to provide a flexible container that provides acceptable sensory feedback to the user when stored liquid is being discharged.

According to one aspect, the present invention relates to a flexible container for storing fluid, the container including a body and a neck portion. The body has a hollow interior and is formed of at least one flexible sheet. The neck portion is integral with the body and formed of the at least one flexible sheet. The neck portion defines a discharge passage between the hollow interior of the body and an opening. The discharge passage of the neck portion has a width in a range of 0.25-0.50 in. when sides of the at least one flexible sheet are flat against one another at the neck portion, and a length between the body and the opening in a range of 0.37-0.62 in.

In another aspect, the present invention relates to a flexible container for storing fluid, including a body and a neck portion. The body has a hollow interior and is formed of at least one flexible sheet. The neck portion is secured to the body and defines a discharge passage between the hollow interior of the body and an opening. The discharge passage of the neck portion has an effective cross-sectional area in a range of 0.010-0.018 in.² and a length between the body and the opening in a range of 0.37-0.62 in.

In still another aspect, the present invention relates to a flexible container for storing fluid, including a body and a neck portion. The body has a hollow interior and is formed of at least one flexible sheet. The neck portion is integral with the body and defines a discharge passage between the hollow interior of the body and an opening. The communication passage of the neck portion is dimensioned such that, for a fluid having a viscosity and a density approximately that of water, the fluid will not discharge from the hollow interior of the body when the body is subjected to applied pressure less than 0.1 psi as the container is tilted from vertical, until the container is angled 70 degrees or more from vertical.

In yet another aspect, the present invention relates to a flexible container for storing fluid, including a body and a neck. The body has a hollow interior and is formed of at least one flexible sheet. The neck portion is integral with the body and defines a discharge passage between the hollow interior of the body and an opening. The discharge passage of the neck portion is dimensioned such that, for a fluid having a viscosity and a density approximately that of water, the fluid will smoothly discharge from the hollow interior of the body if the body is subjected to an applied pressure of 0.1 psi to 0.25 psi.

These and other objects, aspects, features and advantages of the present invention will become apparent from the following detailed description of the preferred embodiments taken in conjunction with the accompanying drawings.

### BRIEF DESCRIPTION OF THE DRAWINGS

FIG. 1 is a perspective view of the flexible container according to a first embodiment of the present invention.

FIG. 2 is a plan view of the flexible container according to the first embodiment of the present invention.

FIG. 3 is a perspective view of the flexible container according to a second embodiment of the present invention.

FIG. 4 is a plan view of the flexible container according to the second embodiment of the present invention.

FIG. 5 is a perspective view of the flexible container according to a third embodiment of the present invention.

FIG. 6 is a plan view of the flexible container according to the third embodiment of the present invention.

### DETAILED DESCRIPTION OF THE PREFERRED EMBODIMENTS

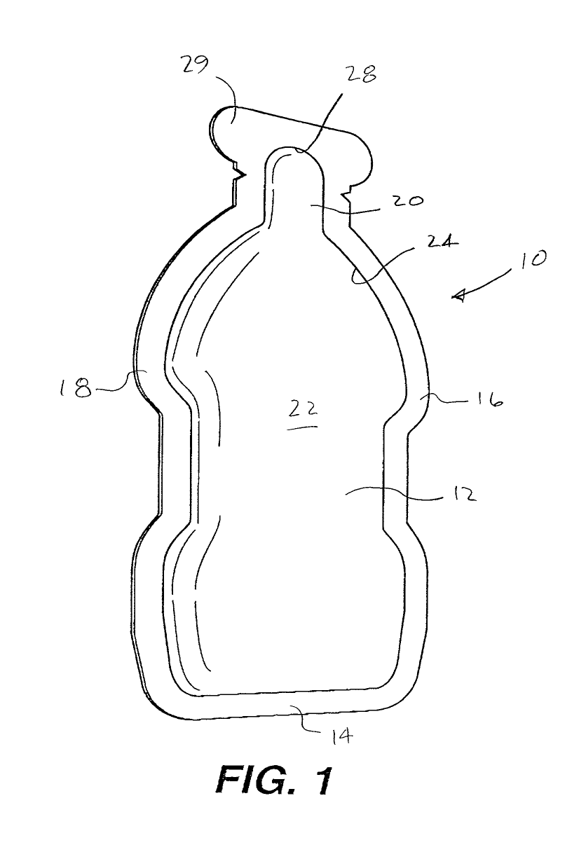

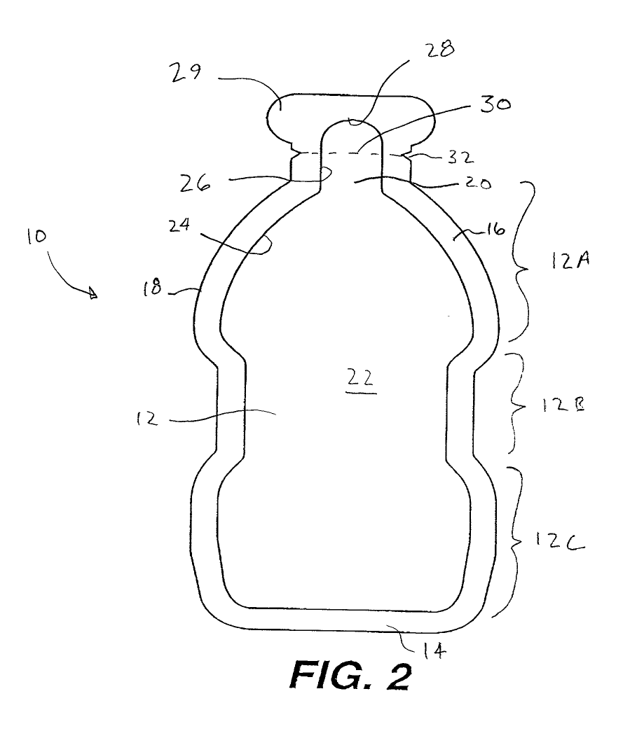

Referring to FIGS. 1 and 2, there is illustrated by way of example, but not limitation, a first embodiment of a flexible container or pouch generally designated at 10. Container 10 includes a hollow body portion 12 defined by a permanently sealed end 14, sides 16, 18 and neck portion 20. Body 12 includes three integral sections: upper section 12A, middle section 12B and base section 12C. Upper section 12A is formed with shoulders 24 that slope from middle section 12B to neck portion 20.

In a preferred embodiment, container 10 is formed of two flexible sheets 22, which are fused about their peripheries to define body portion 12 and neck portion 20. Fusion zones on either side of neck portion 20 define straight edges 26 which terminate at an end portion 28. End portion 28 seals in the fluid contents within container 10 and includes flared tabs 29 for grasping the end portion with the fingers of a user. When the top portion of the neck portion 20 is removed, an opening 30 is formed in the neck portion to define a discharge passage or spout. Notches 32 or a score line are formed in the material forming neck portion 20 to facilitate tearing neck portion 20 at the intended location.

The three sections of body 12 form a generally hourglass shape. Upper section 12A is formed of a sufficient width to be securely grasped by the fingers of a user when tearing off the top portion of neck portion 20. Middle section 12B is of a reduced width as compared to that of upper section 12A and base section 12C. This reduced middle section can be grasped by a user when discharging the contents.

In use, container 10 is filled with liquid to a level that fills body portion 12, but is absent in neck portion 20. Accordingly, the two flexible sheets 22 lie flat against one another at neck portion 20. In order to access the liquid contents, a user grasps container 10 at upper section 12A with one hand and tabs 29 of neck 20 with the other. The upper portion of neck 20 can then be torn off along notches 32 to create opening 30. To discharge the contents, container 10 is grasped about middle section 12B, angled over the receptacle into which it is to be poured, and squeezed. As the liquid is forced through neck portion 20, sheets 22 separate from one another, forming an orifice through which the liquid passes.

Container 10 is designed to have certain specific characteristics. Initially, in dispensing, for example, a liquid having roughly the viscosity and density of water, it is desirable to control the position from vertical at which dripping of the liquid contents is suppressed and at which the liquid will reliably discharge from opening 30 when a minimum pressure is applied to the container. By controlling this discharge angle, container 10 can be reliably positioned over a vessel into which the stored liquid is to be discharged without concern of dripping or spillage. It has been found that a discharge angle of at least 70° from vertical best facilitates controlling the position of the discharge flow.

It is also important that the pressure applied by a user in order to smoothly evacuate the contents of the container be neither too high nor too low. If relatively low discharge pressure is needed to evacuate the liquid or cause a smooth flow, it would be difficult for a user to handle the container without discharging at least some of the liquid. That is, merely holding an open container without applying a squeezing pressure could cause discharge of liquid. If the required pressure is relatively high, the exhausting liquid may cause splashing or splattering and would be difficult to aim while exerting such force. It has been found that an applied discharge pressure in a range of 0.1 to 0.5 psi, and more preferably 0.1 to 0.25 psi, that completely evacuates the liquid in a smooth flow is most effective.

Another characteristic important to containers according to the present invention relates to sensory feedback. This is defined as a user's perception of speed and quantity of the liquid contents as it is discharged from the container. Sensory feedback is deemed to be poor in a case of insufficient control of the discharging liquid stream, whether due to sudden liquid evacuation or a high velocity liquid stream. Sensory feedback is deemed to be good if the liquid stream can be accurately directed within a fine degree, such as toward any point in a cup orifice.

It is also preferable that, even after container 10 has been opened, liquid will not spill out unintentionally, even when the container is laid on its side. That is, the spout orifice will remain closed if no external pressure is applied, thereby preventing entry of atmosphere.

It has been found that the width, length and shape of the spout of the neck portion as well as the shape of the shoulders 24 affect the foregoing characteristics. The width of the spout is defined as the distance between edges 26 when sheets 22 forming neck portion 20 lay flat against one another, that is, when no liquid is forced through neck portion 20. The length of the spout is defined as the distance between shoulder 24 and opening 30. The inventors have discovered that a spout width of 0.25 to 0.50 in. and a length from the shoulder to the opening of 0.37 to 0.62 in. achieves superior results in dispensing a fluid having roughly the viscosity and density of water, particularly for containers of a volume of 0.646-0.900 fl. oz. A shoulder 24 having a concave curvature aids in improving the effectiveness of the design. In a preferred embodiment, the height of the shoulders (the distance between the neck portion 20 and middle section 12B) is approximately 2 in. with a radius of curvature of 1.9 in. As to that the shape of the spout, straight edges 26 are more effective than flared or curved edges.

In a most preferred design, the container has a straight-edged spout of a width of 0.50 in. and a height of 0.37 in., a smooth concave shoulder 24 and a volume of 0.646-0.900 fl. oz. This preferred design achieves superior results as far as discharge angle, discharge pressure, sensory feedback and leakage are concerned. In particular, in discharging a fluid having roughly the viscosity and density of water (e.g., a specific gravity of around 1.15), none of the liquid discharged from opening 30 until the container was angled 70° from vertical. When at the discharge angle, the liquid was discharged in a smooth stream with an applied discharge pressure of 0.1-0.25 psi. In addition, the sensory feedback was judged to be good. That is, with the applied pressure of 0.1-0.25 psi, the discharging stream could be directed to any desired point. Also, when opened container 10 was placed on its side, no liquid leaked out through the spout.

With the preferred design, when pressure of 0.1-0.25 psi was applied, opening 30 did not fully open. Rather, a roughly diamond-shaped central orifice was formed by the fluid flow. This effective orifice opening, which ranged from 0.010-0.018 in.² in cross-section, aided in controlling evacuation and positioning of the fluid.

Container 10 is preferably formed by heat sealing two parallel webs to form the desired shape. Prior to filling, a portion of the periphery of each container 10 is not fused to allow an opening for filling with the fluid. For example, the bottom of container 10 is not sealed in the forming process until after the container has been filled with a fluid product.

Sheets 22 can be formed of any flexible material, such as polyethylene and polyvinyl. A specific type of material can be selected depending on the permeability requirements for the product contents. However, a specific material, CURLAM® Grade 1849-K manufactured by Curwood Co., Oshkosh, Wis., was used in the preferred embodiment. This material is formed of 48 ga polyester adhered to 3.0 mil EVOH/LLDPE Coex. It has been found that the elasticity and weight of this material is of a degree that aid in the performance of the container. In addition, the barrier properties of CURLAM® Grade 1849-K aid in increasing the shelf-life of perishable liquid products.

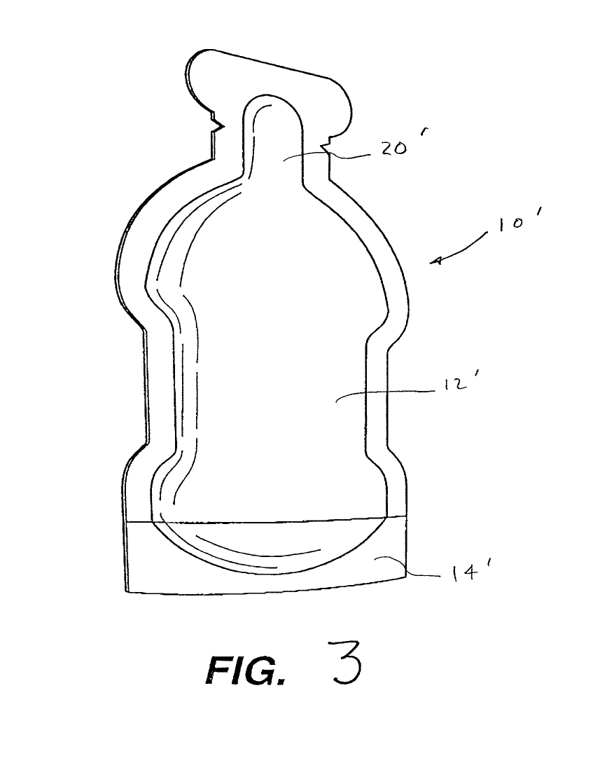

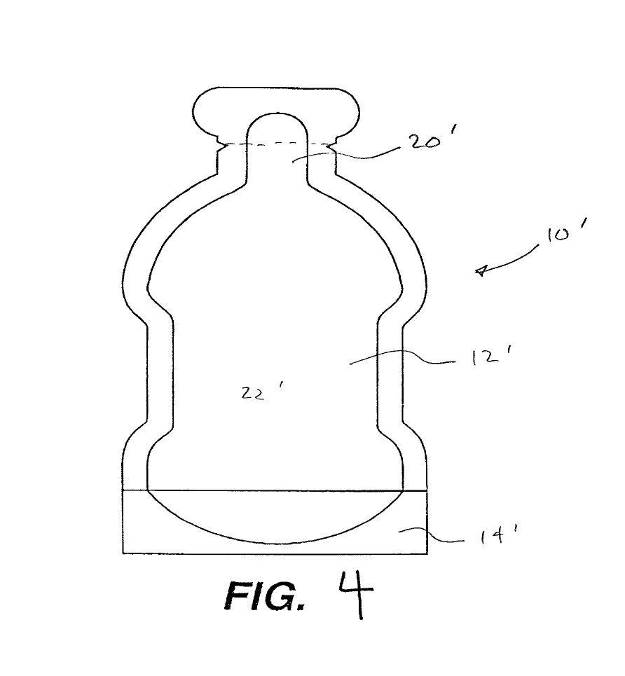

A second embodiment of the present invention is shown in FIGS. 3 and 4. Container 10′ includes a flared bottom 14′ so as to be self-standing. Neck portion 20′ and upper and middle regions 12A′, 12B′, are formed in a similar manner as the first embodiment. However, in forming bottom section 12C′, one of the sheets 22′ is formed longer than the other and the extension is folded upon itself in the manufacturing process to form a folded, flared bottom. Such folds are well-known in the package-forming arts.

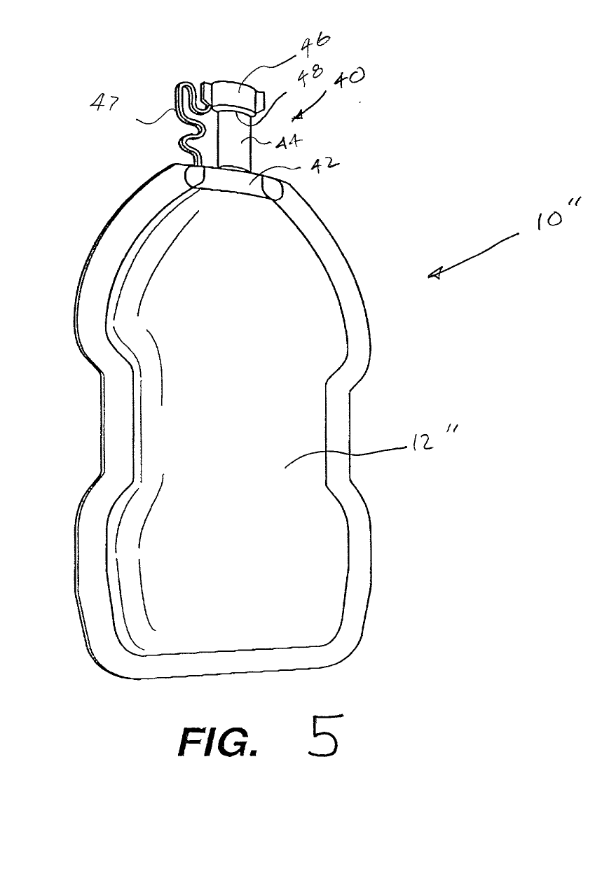

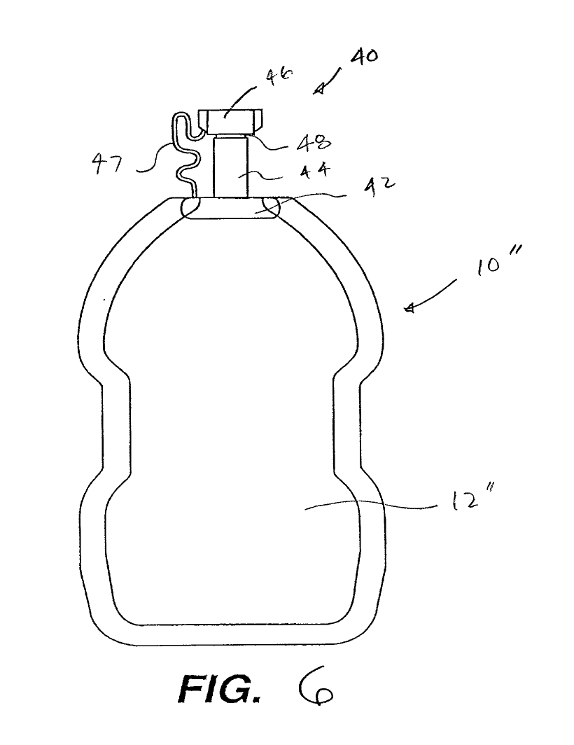

A third embodiment of the present invention is shown in FIGS. 5 and 6. Rather than forming the neck portion 20″ of container 10″ of the same material as body portion 12″, a preformed fitment 40 is secured to the body portion. Fitment 40 includes securing shoulder 42, neck 44 and break-off cap 46. A flexible connector 47 connects neck 44 and cap 46, after they are separated. Shoulder 42 is secured to an opening of body portion 12″. Cap 46 is prefabricated to be integral with neck 44 so as to seal the opening in the neck. A preformed score or crease 48 is formed between neck 44 and cap 46 to enable the cap to be separated from neck 44 when desired to be used. Fitments of this design are well-known, such as those made by Menshan Co., Waldwick, N.J. As an option, cap 46 can be designed to have a flared, hollow top end, such that after it is broken off, the cap can be inverted to reseal neck 44.

While the present invention has been described as to what is currently considered to be the preferred embodiments, it is to be understood that the invention is not limited to them. To the contrary, the invention is intended to cover various modifications and equivalent arrangements within the spirit and scope of the appended claims. The scope of the following claims is to be accorded the broadest interpretation so as to encompass all such modifications and equivalent structures and functions.

What is claimed is:

1. A flexible container for storing fluid, said container comprising:
a body having a hollow interior, said body formed of at least one flexible sheet; and
a neck portion integral with said body and formed of the at least one flexible sheet, said neck portion defining a discharge passage between said hollow interior of said body and an opening, the discharge passage of said neck portion having a width in a range of 0.25-0.50 in. when sides of the at least one flexible sheet are flat against one another at the neck portion, and a length between said body and the opening in a range of 0.37-0.62 in.

2. A flexible container according to claim 1, wherein the discharge passage has a width of 0.50 in. and a length of 0.37 in.

3. A flexible container according to claim 1, wherein said neck portion is of a length greater than the length of the discharge passage, the opening in the discharge passage being formed by removing a section of said neck portion beyond the length of the discharge passage.

4. A flexible container according to claim 3, wherein the position of the opening of said discharge passage is defined by a score line or notch in said neck portion.

5. A flexible container according to claim 1, wherein a shoulder section is defined at the periphery of said body adjacent to said neck portion, said shoulder section forming a smooth curve to said neck portion.

6. A flexible container according to claim 5, wherein said shoulder section has a radius of curvature of about 1.9 in.

7. A flexible container according to claim 1, wherein the at least one flexible sheet is formed of polyester layered on EVOH/LLDPE Coex.

8. A flexible container according to claim 1, wherein edges of said neck portion are straight.

9. A flexible container according to claim 1, wherein said body is formed of two flexible sheets secured to one another at their peripheries.

10. A flexible container according to claim 1, wherein said container has a capacity of 0.646-0.900 fl. oz.

11. A flexible container for storing fluid, said container comprising:
a body having a hollow interior, said body formed of at least one flexible sheet; and
a neck portion secured to said body, said neck portion defining a discharge passage between said hollow interior of said body and an opening, the discharge passage of said neck portion having an effective cross-sectional area in a range of 0.010-0.018 in.² and a length between said body and the opening in a range of 0.37-0.62 in.

12. A flexible container according to claim 11, wherein the discharge passage has an effective cross-sectional area of 0.014 in.² and a length of 0.37 in.

13. A flexible container according to claim 11, wherein said neck portion is of a length greater than the length of the discharge passage, the opening in the discharge passage being formed by removing a section of said neck portion beyond the length of the discharge passage.

14. A flexible container according to claim 13, wherein the position of the opening of said discharge passage is defined by a score line or notch in said neck portion.

15. A flexible container according to claim 11, wherein a shoulder section is defined at the periphery of said body adjacent to said neck portion, said shoulder section forming a smooth curve to said neck portion.

16. A flexible container according to claim 15, wherein said shoulder section has a radius of curvature of about 1.9 in.

17. A flexible container according to claim 11, wherein the at least one flexible sheet is formed of polyester layered on EVOH/LLDPE Coex.

18. A flexible container according to claim 11, wherein said body is formed of two flexible sheets secured to one another at their peripheries.

19. A flexible container according to claim 11, wherein said neck portion is formed of a rigid material.

20. A flexible container according to claim 11, wherein said neck portion is formed of the same material as and integrally with said body.

21. A flexible container according to claim 20, wherein edges of said neck portion are straight.

22. A flexible container according to claim 20, wherein the effective cross-sectional area of said neck portion ranges from 0.010-0.018 in² as the fluid having a density and viscosity approximately that of water is discharged therethrough upon application of a pressure of 0.1-0.25 psi.

23. A flexible container according to claim 11, wherein said container has a capacity of 0.646-0.900 fl. oz.

24. A flexible container for storing fluid, said container comprising:
a body having a hollow interior, said body formed of at least one flexible sheet; and
a neck portion integral with said body, said neck portion defining a discharge passage between said hollow interior of said body and an opening, the communication passage of said neck portion being dimensioned such that, for a fluid having a viscosity and a density approximately that of water, the fluid will not flow from the hollow interior of said body when said body is subjected to applied pressure less than 0.1 psi as said container is tilted from vertical, until said container is angled at least 70 degrees from vertical.

25. A flexible container according to claim 24, wherein said discharge passage has a width in a range of 0.25-0.50 in. when sides of the at least one flexible sheet are flat against one another at said neck portion, and a length between said body and the opening in a range of 0.37-0.62 in.

26. A flexible container according to claim 25, wherein the discharge passage has a width of 0.50 in. and a length of 0.37 in.

27. A flexible container according to claim 24, wherein said discharge passage has an effective cross-sectional area in a range of 0.010-0.018 in.² and a length in a range of 0.37-0.62 in.

28. A flexible container according to claim 27, wherein said discharge passage has an effective cross-sectional area of 0.014 in.² and a length of 0.37 in.

29. A flexible container according to claim 24, wherein said neck portion is of a length greater than the length of the discharge passage, the opening in the discharge passage being formed by removing a section of said neck portion beyond the length of the discharge passage.

30. A flexible container according to claim 29, wherein the position of the opening of said discharge passage is defined by a score line or notch in said neck portion.

31. A flexible container according to claim 24, wherein a shoulder section is defined at the periphery of said body adjacent to said neck portion, said shoulder section forming a smooth curve to said neck portion.

32. A flexible container according to claim 31, wherein said shoulder section has a radius of curvature of about 1.9 in.

33. A flexible container according to claim 24, wherein the at least one flexible sheet is formed of polyester layered on EVOH/LLDPE Coex.

34. A flexible container according to claim 24, wherein edges of said neck portion are straight.

35. A flexible container according to claim 24, wherein said body is formed of two flexible sheets secured to one another at their peripheries.

36. A flexible container according to claim 24, wherein said container has a capacity of 0.646-0.900 fl. oz.

37. A flexible container for storing fluid, said container comprising:
a body having a hollow interior, said body formed of at least one flexible sheet; and
a neck portion integral with said body, said neck portion defining a discharge passage between said hollow interior of said body and an opening, the discharge passage of said neck portion being dimensioned such that, for a fluid having a viscosity and a density approximately that of water, the fluid will smoothly discharge from the hollow interior of said body if said body is subjected to an applied pressure of 0.1-0.25 psi.

38. A flexible container according to claim 37, wherein said discharge passage has a width in a range of 0.25-0.50 in. when sides of the at least one flexible sheet are flat against one another at said neck portion, and a length between said body and the opening in a range of 0.37-0.62 in.

39. A flexible container according to claim 38, wherein the discharge passage has a width of 0.50 in. and a length of 0.37 in.

40. A flexible container according to claim 37, wherein said discharge passage has an effective cross-sectional area in a range of 0.010-0.018 in.² and a length in a range of 0.37-0.62 in.

41. A flexible container according to claim 40, wherein said discharge passage has an effective cross-sectional area of 0.014 in.² and a length of 0.37 in.

42. A flexible container according to claim 37, wherein said neck portion is of a length greater than the length of the discharge passage, the opening in the discharge passage being formed by removing a section of said neck portion beyond the length of the discharge passage.

43. A flexible container according to claim 42, wherein the position of the opening of said discharge passage is defined by a score line or notch in said neck portion.

44. A flexible container according to claim 37, wherein a shoulder section is defined at the periphery of said body adjacent to said neck portion, said shoulder section forming a smooth curve to said neck portion.

45. A flexible container according to claim 44, wherein said shoulder section has a radius of curvature of about 1.9 in.

46. A flexible container according to claim 37, wherein the at least one flexible sheet is formed of polyester layered on EVOH/LLDPE Coex.

47. A flexible container according to claim 37, wherein edges of said neck portion are straight.

48. A flexible container according to claim 37, wherein said body is formed of two flexible sheets secured to one another at their peripheries.

49. A flexible container according to claim 37, wherein said container has a capacity of 0.646-0.900 fl. oz.
